(19) United States
(12) Patent Application Publication
(10) Pub. No.: US 2024/0243527 A1
(43) Pub. Date: Jul. 18, 2024

(54) CONNECTING STRUCTURE AND SIGNAL TRANSMISSION SYSTEM

(71) Applicant: CYNTEC CO., LTD., Hsinchu (TW)

(72) Inventors: Shih-Hsien Tseng, Hsinchu (TW); Sheng-Ju Chou, Hsinchu (TW); Ming-Feng Chiang, Hsinchu (TW)

(73) Assignee: CYNTEC CO., LTD., Hsinchu (TW)

(21) Appl. No.: 18/413,058

(22) Filed: Jan. 16, 2024

Related U.S. Application Data
(60) Provisional application No. 63/439,530, filed on Jan. 17, 2023.

(51) Int. Cl. H01R 13/6585; H01R 12/77; H01R 12/79; H01R 13/6461

(52) U.S. Cl. CPC H01R 13/6585; H01R 12/771; H01R 12/79; H01R 13/6461

(57) ABSTRACT

A connecting structure includes a flexible flat cable. The flexible flat cable includes a first end portion, a second end portion, a connecting portion, a first pad region, a second pad region and a slot. The connecting portion is connected between the first end portion and the second end portion. The first pad region is disposed on the first end portion. The second pad region is disposed on the second end portion. The slot is formed in the connecting portion. The slot is extended along a length direction of the flexible flat cable. The flexible flat cable is a laminated structure including at least one set of signal trace pattern and at least one shielding structure. The at least one shielding structure correspondingly surrounds the at least one set of signal trace pattern in the connecting portion.

### CROSS REFERENCE TO RELATED APPLICATIONS

This application claims the benefit of U.S. Provisional Application No. 63/439,530, filed on Jan. 17, 2023. The content of the application is incorporated herein by reference.

### BACKGROUND OF THE INVENTION

### 1. Field of the Invention

The present disclosure relates to a connecting structure and a signal transmission system, and more particularly, to a connecting structure and a signal transmission system favorable for the application of high-speed signal transmission.

### 2. Description of the Related Art

In general, electrical devices, such as an optical module or an integrated circuit, mounted on a printed circuit board (PCB) may transmit signals through the trace pattern of the PCB. However, excessive insertion loss may occur in the high-speed signal transmission. Therefore, how to improve the quality of high-speed signal transmission has become a goal of relevant industries.

### SUMMARY OF THE INVENTION

According to an embodiment of the present disclosure, a connecting structure includes a flexible flat cable. The flexible flat cable includes a first end portion, a second end portion, a connecting portion, a first pad region, a second pad region and a slot. The connecting portion is connected between the first end portion and the second end portion. The first pad region is disposed on the first end portion. The second pad region is disposed on the second end portion. The slot is formed in the connecting portion. The slot is extended along a length direction of the flexible flat cable. The flexible flat cable is a laminated structure including at least one set of signal trace pattern and at least one shielding structure. The at least one shielding structure correspondingly surrounds the at least one set of signal trace pattern in the connecting portion.

According to another embodiment of the present disclosure, a signal transmission system includes a system board, a first device, a second device and a connecting structure. The first device is coupled to the system board. The first device is configured to provide a high-speed signal and a low-speed signal. The second device is coupled to the system board. The connecting structure includes a flexible flat cable. The flexible flat cable includes a first end portion, a second end portion, a connecting portion, a first pad region and a second pad region. The first end portion and the second end portion are respectively coupled to the first device and the second device. The first pad region is disposed on the first end portion. The second pad region is disposed on the second end portion. The flexible flat cable is a laminated structure including at least one set of signal trace pattern and at least one shielding structure. The at least one shielding structure correspondingly surrounds the at least one set of signal trace pattern in the connecting portion. The low-speed signal is transmitted from the first device to the second device through the system board, and the high-speed signal is transmitted from the first device to the second device through the connecting structure.

According to yet another embodiment of the present disclosure, a connecting structure includes two flexible flat cables and a fixing member. Each of the flexible flat cables includes a first end portion, a second end portion, a connecting portion, a first pad region and a second pad region. The connecting portion is connected between the first end portion and the second end portion. The first pad region is disposed on the first end portion. The second pad region is disposed on the second end portion. Each of the flexible flat cables is a laminated structure including at least one set of signal trace pattern and at least one shielding structure. The at least one shielding structure correspondingly surrounds the at least one set of signal trace pattern in the connecting portion. The two flexible flat cables are arranged along a vertical direction, and there is a space between the two connecting portions of the two flexible flat cables. The fixing member is disposed at one side of the connecting portion of each of the two flexible flat cables adjacent to the first end portion to bond the two flexible flat cables.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three-dimensional diagram showing a connecting structure according to an embodiment of the present disclosure.

FIG. 2 is an enlarged view of a portion P1 shown in FIG. 1.

FIG. 3 schematically illustrates a cross-sectional view taken along a line A-A′ in FIG. 1.

FIG. 4 schematically illustrates a cross-sectional view taken along a line B-B′ in FIG. 2.

FIG. 5 is an exploded diagram showing a flexible flat cable shown in FIG. 2.

FIG. 6 is a three-dimensional diagram showing a connecting structure according to another embodiment of the present disclosure

FIG. 7, which is a three-dimensional diagram showing a portion of a connecting structure according to yet another embodiment of the present disclosure.

FIG. 8 is a combination schematic diagram of a connecting structure and a connector according to yet another embodiment of the present disclosure.

FIG. 9 schematically illustrates a cross-sectional view taken along a line C-C′ in FIG. 8.

FIG. 10 is a combination schematic diagram of a connecting structure and a connector according to yet another embodiment of the present disclosure.

FIG. 11 is a combination schematic diagram of the connecting structure and a connector according to yet another embodiment of the present disclosure.

FIG. 12 is a three-dimensional diagram showing a portion of a connecting structure according to yet another embodiment of the present disclosure.

FIG. 13 is a combination schematic diagram of the connecting structure and a connector according to yet another embodiment of the present disclosure.

FIG. 14 schematically illustrates a cross-sectional view of the portion P2 shown in FIG. 13.

FIG. 15 is a three-dimensional diagram showing a connecting structure according to yet another embodiment of the present disclosure.

FIG. 16 is a schematic diagram showing a signal transmission system according to an embodiment of the present disclosure.

FIG. 17 is a three-dimensional diagram showing the connector and the connecting structure shown in FIG. 16.

### DETAILED DESCRIPTION

In the following detailed description of the embodiments, reference is made to the accompanying drawings which form a part thereof, and in which is shown by way of illustration specific embodiments in which the disclosure may be practiced. In this regard, directional terminology, such as up, down, left, right, front, back, bottom or top is used with reference to the orientation of the Figure(s) being described. The elements of the present disclosure can be positioned in a number of different orientations. As such, the directional terminology is used for purposes of illustration and is in no way limiting. In addition, identical numeral references or similar numeral references are used for identical elements or similar elements in the following embodiments.

Hereinafter, for the description of “the first feature is formed on or above the second feature”, it may refer that “the first feature is in contact with the second feature directly”, or it may refer that “there is another feature between the first feature and the second feature”, such that the first feature is not in contact with the second feature directly.

It is understood that, although the terms first, second, etc. may be used herein to describe various elements, regions, layers and/or sections, these elements, regions, layers and/or sections should not be limited by these terms. These terms may be only used to distinguish one element, region, layer and/or section from another element, region, layer and/or section. Terms such as “first,” “second,” and other numerical terms when used herein do not imply a sequence or order unless clearly indicated by the context. Thus, a first element, region, layer and/or section discussed below could be termed a second element, region, layer and/or section without departing from the teachings of the embodiments. The terms used in the claims may not be identical with the terms used in the specification, but may be used according to the order of the elements claimed in the claims.

The term “electrically connected”, “electrically contact” or “coupled to” includes means of direct or indirect electrical connection.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

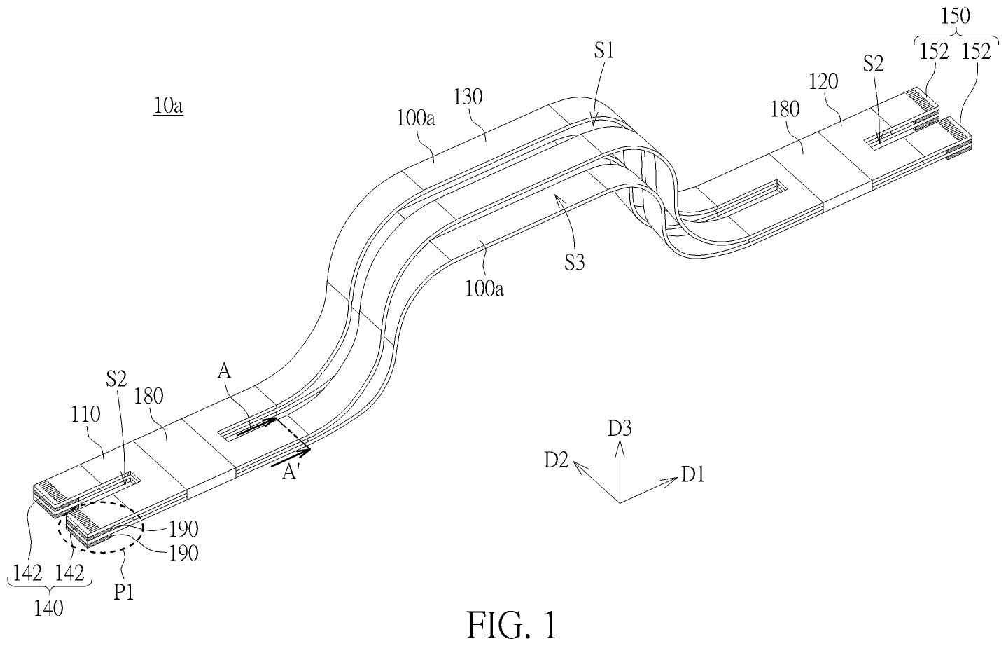

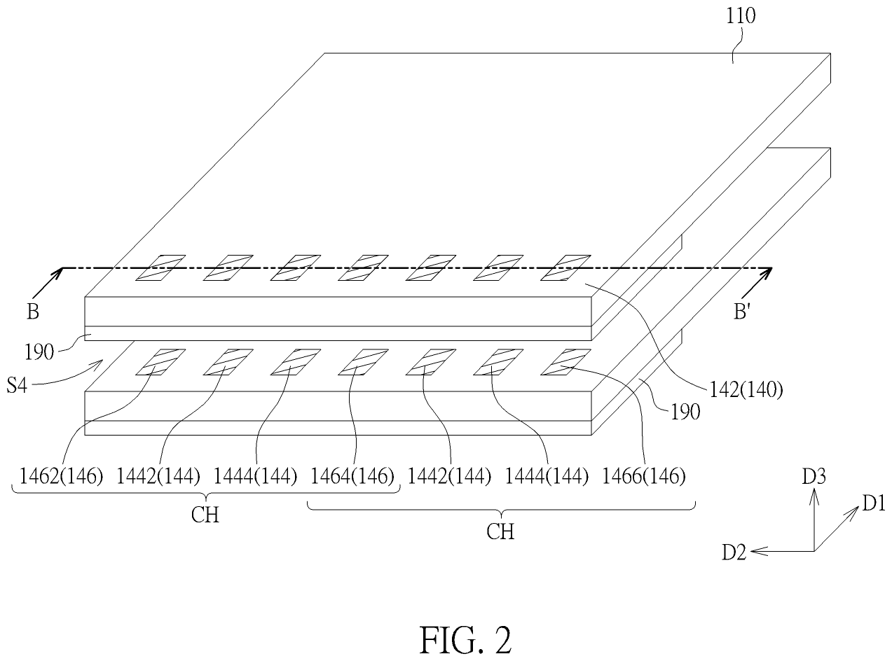

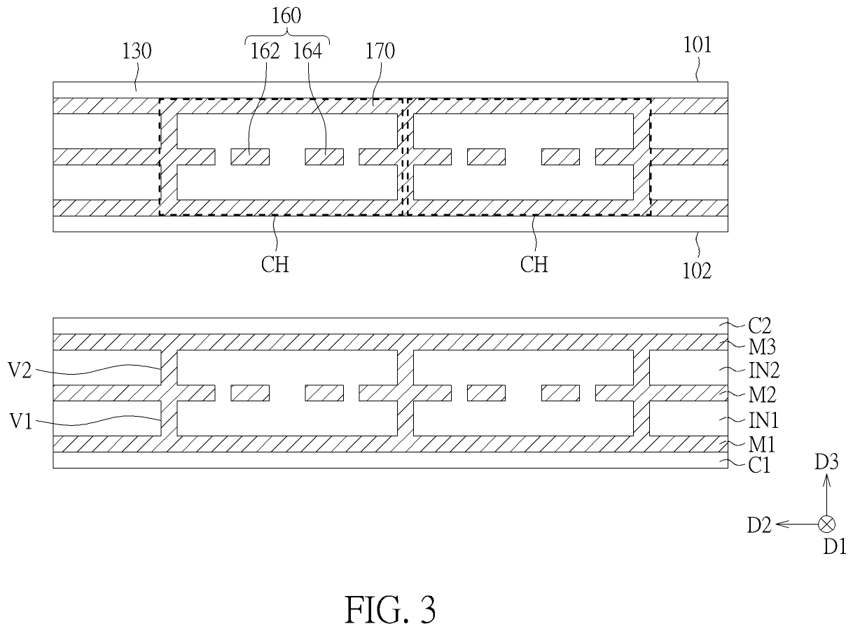

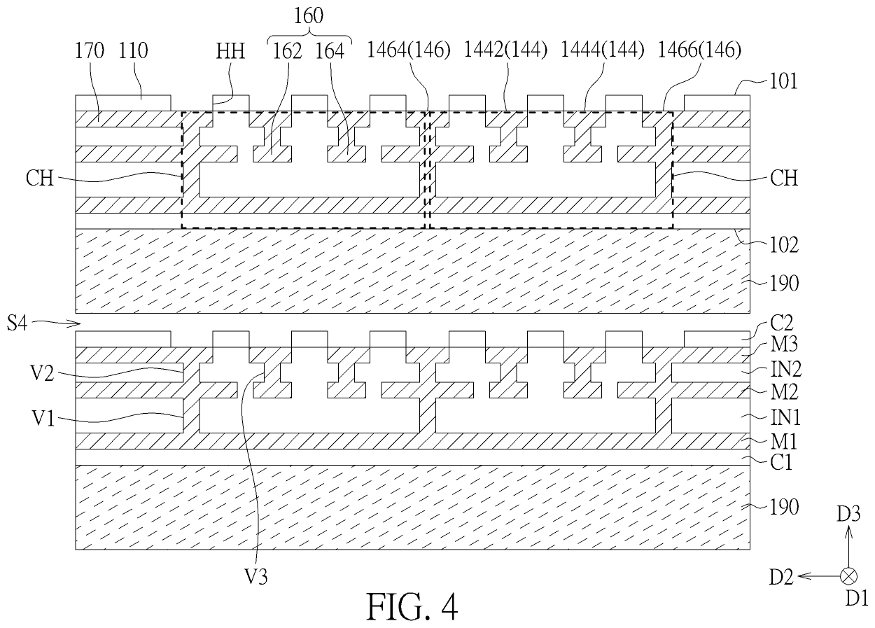

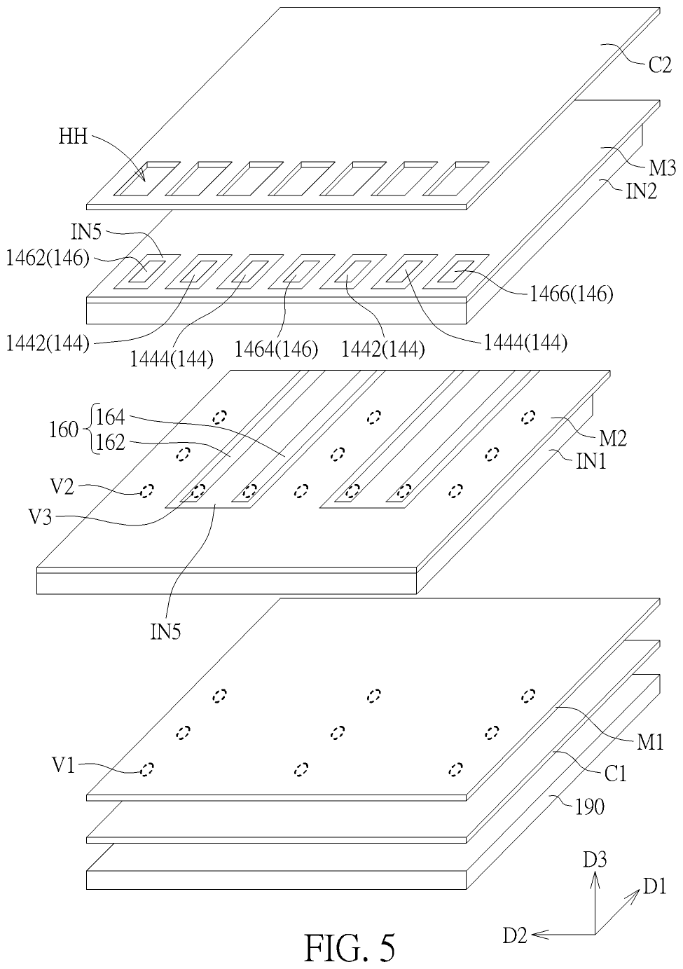

Please refer to FIG. 1 to FIG. 5. FIG. 1 is a three-dimensional diagram showing a connecting structure 10a according to an embodiment of the present disclosure. FIG. 2 is an enlarged view of a portion P1 shown in FIG. 1. FIG. 3 schematically illustrates a cross-sectional view taken along a line A-A′ in FIG. 1. FIG. 4 schematically illustrates a cross-sectional view taken along a line B-B′ in FIG. 2. FIG. 5 is an exploded diagram showing a flexible flat cable 100a shown in FIG. 2. As shown in FIG. 1, the connecting structure 10a includes two flexible flat cables 100a. Each of the flexible flat cables 100a includes a first end portion 110, a second end portion 120, a connecting portion 130, a first pad region 140, a second pad region 150 and a slot S1. The connecting portion 130 is connected between the first end portion 110 and the second end portion 120. The first pad region 140 is disposed on the first end portion 110. The second pad region 150 is disposed on the second end portion 120. The slot S1 is formed in the connecting portion 130. The slot S1 is extended along the length direction D1 of the flexible flat cable 100a. As shown in FIGS. 3-5, the flexible flat cable 100a is a laminated structure including at least one set of signal trace pattern 160 and at least one shielding structure 170. The at least one shielding structure 170 correspondingly surrounds the at least one set of signal trace pattern 160 in the connecting portion 130. With the slot S1, it is favorable for reducing the bending stress and/or twist stress during assembly.

The flexible flat cable 100a may include a flexible circuit or a flexible printed circuit (FPC). The length direction D1 of the flexible flat cable 100a may be parallel to an assembling direction of the flexible flat cable 100a. The assembling direction may be the direction that the flexible flat cable 100a is assembled with (or inserted into or plugged into) a connector. The width direction D2 of the flexible flat cable 100a may be perpendicular to the length direction D1 of the flexible flat cable 100a. The first surface 101 (see FIG. 3) of the flexible flat cable 100a may define a normal direction (not shown), and the vertical direction D3 may be parallel to the normal direction.

Herein, the number of the flexible flat cables 100a is two, and the two flexible flat cables 100a are arranged along the vertical direction D3. The number of the flexible flat cables 100a is exemplarily and the present disclosure is not limited thereto. For example, the number of the flexible flat cables 100a may be one, three, four, etc. That is, the number of the flexible flat cables 100a may be adjusted according to actual need. When the connecting structure 10a includes a plurality of flexible flat cables 100a, it is favorable for increasing the channel density.

The first end portions 110 of the two flexible flat cables 100a may be bonded with each other. Thereby, it is favorable for simultaneously picking or moving the two flexible flat cables 100a, so that the first end portions 110 of the two flexible flat cables 100a may be assembled with a connector at the same time, so as to achieve one-time assembly. The connecting structure 10a may further include a spacer 190 disposed between the two first end portions 110 of the two flexible flat cables 100a. The first end portions 110 of the two flexible flat cables 100a may be bonded with each other through the spacer 190. The spacer 190 may overlap the two first end portions 190 of the two flexible flat cables 100a. Specifically, the spacer 190 may overlap the signal pads 144 and the ground pads 146 of the two flexible flat cables 100a in the vertical direction D3. In the embodiment, the spacer 190 is only disposed in the first end portion 110 and is not extended to the connecting portion 130. Since the signals (not shown) are transmitted out the flexible flat cables 100a through the signal pads 144 which are not shielded by the shielding structure 170, the isolation property may be enhanced by the spacer 190 so as to prevent the crosstalk from occurring in the first end portion 110. The spacer 190 may be made of a conductive material or a non-conductive material. When the spacer 190 is made of a conductive material, the spacer 190 may reduce the crosstalk through the electromagnetic interference (EMI). When the spacer 190 is made of a non-conductive material, the spacer 190 may be arranged with a thicker thickness to create a lager distance between the two flexible flat cables 100a to reduce the crosstalk. The spacer 190 may be made of a rigid material to strengthen the structural strength. Therefore, with the spacer 190, it is beneficial to reduce the crosstalk between the two flexible flat cables 100a, and it is beneficial to strengthen the structural strength. In some embodiments, each of the flexible flat cables 100a may include the spacer 190 disposed on the second surface 102 opposite to the first surface 101 disposed with the signal pads 144 and ground pads 146 (see FIG. 2 and FIG. 4), which is beneficial to reduce the interference from external signals.

There is a space S3 between the two connecting portions 130 of the two flexible flat cables 100a. That is, the connecting portions 130 of the two flexible flat cables 100a are not bonded with each other. Compared with the configuration that the two connecting portions 130 of the two flexible flat cables 100a are integrally formed or bonded with each other, with the space S3, it is favorable for reducing stress when the two flexible flat cables 100a are assembled on a hard board. Moreover, the two flexible flat cables 100a may be configured with different lengths, so that the two flexible flat cables 100a may be used to transmit signals with different properties.

The connecting structure 10a may further include a fixing member 180 disposed at one side of the connecting portion 130 of each of the two flexible flat cables 100a adjacent to the first end portion 110 to bond the two flexible flat cables 100a. With the fixing member 180, it is favorable for simultaneously picking or moving the two flexible flat cables 100a, which is favorable for simplifying the assembling process, so as to improve the assembly convenience. The fixing member 180, for example, may be a flexible band, but not limited thereto.

According to the configuration of the flexible flat cables 100a, the two flexible flat cables 100a may be fabricated independently, and then the flexible flat cables 100a may be bonded through the spacer 190 and/or the fixing member 180, which is favorable for saving the fabricating cost.

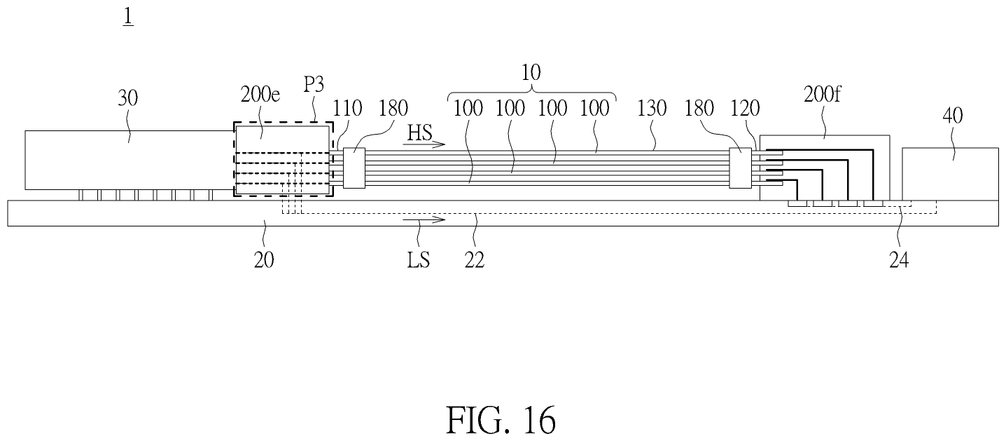

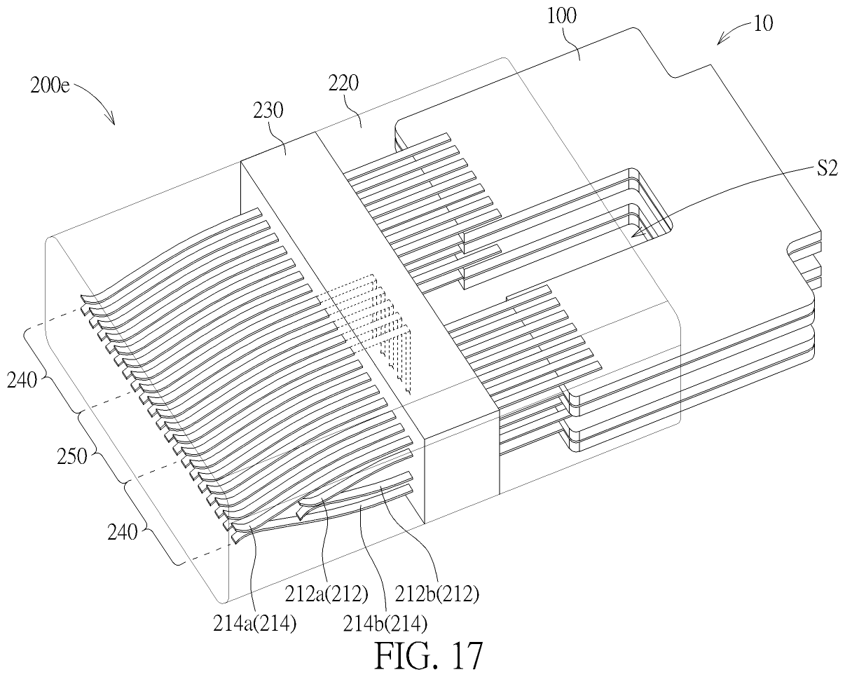

As shown in FIG. 1, the first pad region 140 may include two sub-pad regions 142, and the flexible flat cable 100a may further include a recess S2 formed between the two sub-pad regions 142. The slot S1 is aligned with the recess S2 along the length direction D1 of the flexible flat cable 100a. With the recess S2, it is favorable for the application that the high-speed signal and the low-speed signal are transmitted in different path, which may refer to the description related to FIG. 16 and FIG. 17.

As shown in FIG. 2, each of the sub-pad regions 142 of the first pad region 140 includes a plurality of ground pads 146 and a plurality of signal pads 144, which are a first ground pad 1462, a first signal pad 1442, a second signal pad 1444, a second ground pad 1464, a first signal pad 1442, a second signal pad 1444 and a third ground pad 1466 arranged in sequence along the width direction D2 of the flexible flat cable 100a.

As shown in FIG. 3, in the connecting portion 130, each set of signal trace pattern 160 may surrounded by a corresponding shielding structure 170 to form a channel CH. That is, in the connecting portion 130, the at least one set of signal trace pattern 160 and the shielding structure 170 overlap in the width direction D2 and overlap in the vertical direction D3 of the flexible flat cable 100a. When the flexible flat cable 100a includes a plurality of sets of signal trace patterns 160 and a plurality of shielding structures 170, the plurality of shielding structures 170 correspondingly and respectively surround the plurality of sets of signal trace patterns 160, such that the crosstalk between the signals transmitted by the plurality of sets of signal trace patterns 160 can be prevented. Moreover, the distance between two sets of signal trace patterns 160 or the distance between the set of signal trace pattern 160 and the shielding structure 170 may be accurately defined. Therefore, in the high-speed transmittance, the stability of the electrical properties, such as high-frequency impedance and return loss, of the sets of signal trace patterns 160 may be improved.

In the embodiment, each of the sub-pad regions 142 may include two channels CH. That is, the first pad region 140 or the flexible flat cable 100a may include four channels CH. In some embodiments, each set of signal trace pattern 160 may include a first signal trace pattern 162 and a second signal trace pattern 164 arranged along the width direction D2 of the flexible flat cable 100a. For example, one of the first signal trace pattern 162 and the second signal trace pattern 164 is a positive signal trace pattern, the other one of the first signal trace pattern 162 and the second signal trace pattern 164 is a negative signal trace pattern, so that the first signal trace pattern 162 and the second signal trace pattern 164 form a differential signal pair, and the set of signal trace pattern 160 transmits signals in a differential manner. Thereby, it is favorable for enhancing the degree of signal integrity. In some embodiments, the set of signal trace pattern 160 may only include a single signal trace pattern, and the set of signal trace pattern 160 transmits signals in a non-differential manner. Therefore, it can effectively prevent the sets of signals from being interfered with each other or the flexible flat cable 100a may have a higher volume density when external interference exists.

As shown in FIG. 4, the at least one set of signal trace pattern 160 is electrically connected to the signal pads 144 disposed on the first pad region 140, and the at least one shielding structure 170 is electrically connected to the ground pads 146 disposed on the first pad region 140. In the first pad region 140 of the first end portion 110, the at least one set of signal trace pattern 160 and the shielding structure 170 overlap in the width direction D2 of the flexible flat cable 100a. Specifically, the first signal trace pattern 162 is electrically connected to the first signal pad 1442, and the second signal trace pattern 164 is electrically connected to the second signal pad 1444. The second ground pad 1464 is disposed between the second signal pad 1444 of the channel CH at the left side and the first signal pad 1442 of the channel CH at the right side. That is, the two channels CH share the second ground pad 1464 disposed therebetween.

More specifically, as shown in FIGS. 3-5, each of the flexible flat cable 100a is a laminated structure. The laminated structure includes, from bottom to top, a protective layer C1, a metal layer M1, an insulating layer IN1, a metal layer M2, an insulating layer IN2, a metal layer M3 and a protective layer C2. The signal pads 144 and the ground pads 146 are exposed from the holes HH formed in the protective layer C2. A plurality of vias V1 are formed in the insulating layer IN1, and the metal material (not labeled) is filled in the vias V1, such that the portion of the metal layer M1 and the portion of the metal layer M2 corresponding to the shielding structure 170 are electrically connected with each other. A plurality of vias V2 are formed in the insulating layer IN2, and the metal material (not labeled) is filled in the vias V2, such that the portion of the metal layer M2 corresponding to the shielding structure 170 and the portion of the metal layer M3 corresponding to the ground pads 146 or the shielding structure 170 are electrically connected with each other. The plurality of vias V2 are aligned with the vias V1 respectively. A plurality of vias V3 are formed in the insulating layer IN2, and the metal material (not labeled) is filled in the vias V3, such that and the portion of the metal layer M2 corresponding to the set of signal trace pattern 160 and the portion of the metal layer M3 corresponding to the signal pads 144 are electrically connected with each other. Each of the signal pads 144 and the ground pads 146 may be surrounded by the insulating structure IN5, and each of the first signal trace pattern 162 and the second signal trace pattern 164 may be surrounded by the insulating structure IN5. The protective layers C1 and C2 may include an organic material or an inorganic material. The organic material may include, for example, acrylic, epoxy, resin or other suitable materials. The inorganic material may include, for example, silicon oxide (SiOₓ), silicon nitride (SiNₓ), silicon oxynitride (SiOₓN_{y}) or other suitable materials. The insulating layers IN1 and IN2 may include a plastic material, such as polyimide (PI), polycarbonate (PC), polyethylene terephthalate (PET), polymethyl methacrylate (PMMA) or other suitable materials. The metal layers M1, M2 and M3 may include a metal material, such as copper, silver, gold or other suitable materials.

As shown in FIG. 4, there may be an accommodating space S4 between the two first end portions 110 of the two flexible flat cables 100a in the vertical direction D3. Thereby, when the first end portions 110 are assembled with a connector, it is favorable for the terminals of the connector to insert into the accommodating space S4 to electrically contact the signal pads 144 or the ground pads 146 of the flexible flat cable 100a.

In the embodiment, the configuration of the second end portion 120 is the same as that of the first end portion 110. Specifically, the second end portions 120 of the two flexible flat cables 100a may be bonded with each other. Thereby, it is favorable for simultaneously picking or moving the two flexible flat cables 100a, so that the second end portions 120 of the two flexible flat cables 100a may be assembled with a connector at the same time, so as to achieve one-time assembly. The connecting structure 10a may further include another spacer (not shown) disposed between the two second end portions 120 of the two flexible flat cables 100a. The second end portions 120 of the two flexible flat cables 100a may be bonded with each other through the spacer. The connecting structure 10a may further include another fixing member 180 disposed at one side of the connecting portion 130 of each of the two flexible flat cables 100a adjacent to the second end portion 120 to bond the two flexible flat cables 100a. The second pad region 150 may include two sub-pad regions 152, and the flexible flat cable 100a further includes a recess S2 formed between the two sub-pad regions 152. In other embodiments, the configurations of the first end portion 110 and the second end portion 120 may be different according to actual need.

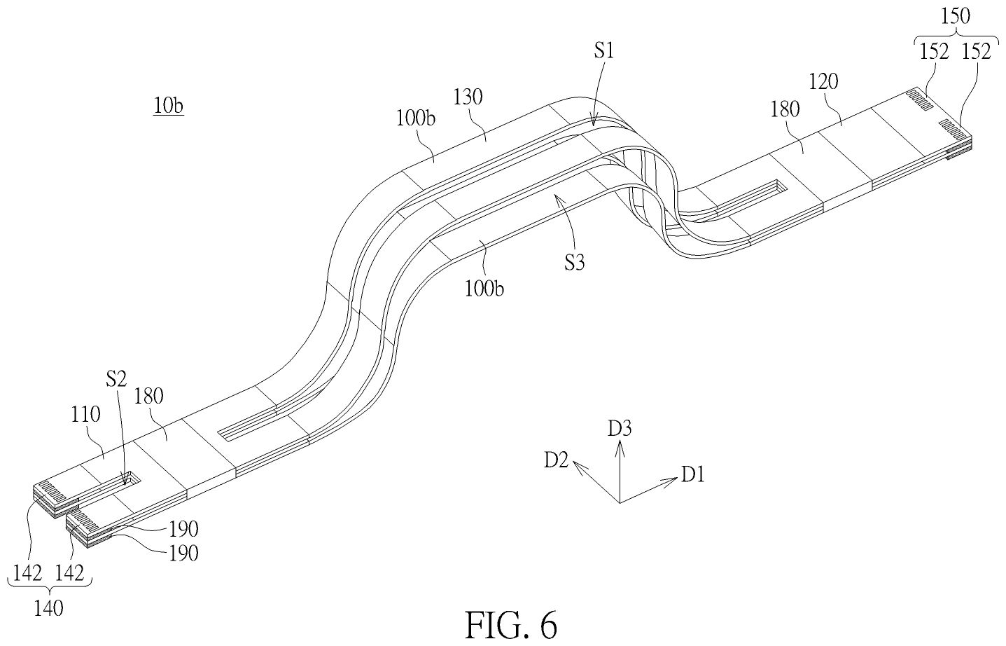

Please refer to FIG. 6, which is a three-dimensional diagram showing a connecting structure 10b according to another embodiment of the present disclosure. The main difference between the connecting structure 10b shown in FIG. 6 and the connecting structure 10a shown in FIG. 1 is the configuration of the second end portion 120 of the flexible flat cable 100b. In FIG. 6, the second pad region 150 includes two sub-pad regions 152, and there is no recess S2 formed between the two sub-pad regions 152.

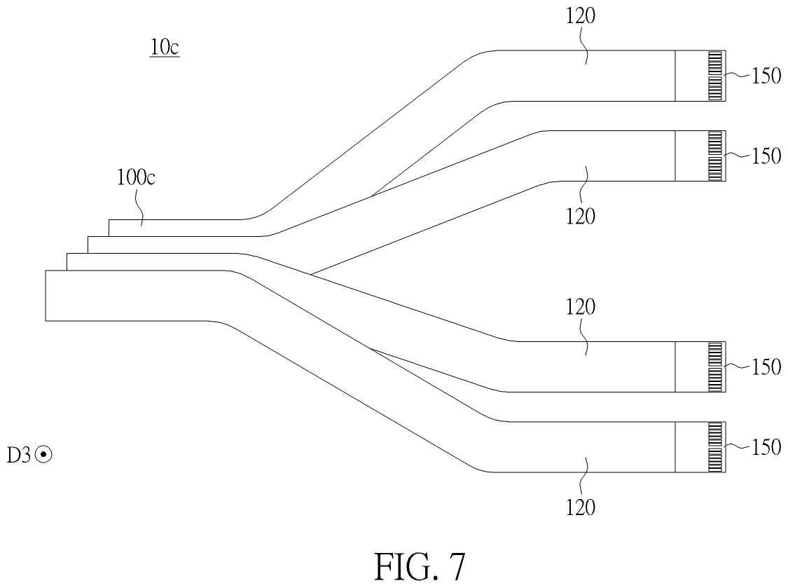

Please refer to FIG. 7, which is a three-dimensional diagram showing a portion of a connecting structure 10c according to yet another embodiment of the present disclosure. In FIG. 7, the connecting structure 10c includes four flexible flat cables 100c. The structure of the flexible flat cable 100c may be the same as the structure of the flexible flat cable 100b shown in FIG. 6. For the sake of simplicity, only the second end portions 120 of the flexible flat cables 100c are shown. Except for the number of the flexible flat cables 100c of the connecting structure 10c being different from the number of the flexible flat cables 100b of the connecting structure 10b, the main difference between the connecting structure 10c shown in FIG. 7 and the connecting structure 10b shown in FIG. 6 is the configuration of the second end portion 120. In FIG. 7, the second end portions 120 of the four flexible flat cables 100c are not bonded with each other. In other words, the second end portions 120 of the flexible flat cables 100c are separated from each other, which is favorable for increasing the freedom of circuit design and the freedom of assembly. For example, the second end portions 120 of the four flexible flat cables 100c may be independently connected to different electrical devices or may be independently connected to different positions of a same electrical device. Furthermore, the connecting methods between the second pad regions 150 and an electrical device (such as the system board 20 shown in FIG. 16) may be more diverse. For example, the second pad region 150 may be connected with an electrical device through inserting into a connector that connects the second pad region 150 and the electrical device or through soldering, crimping or ultrasonic welding, but not limited thereto.

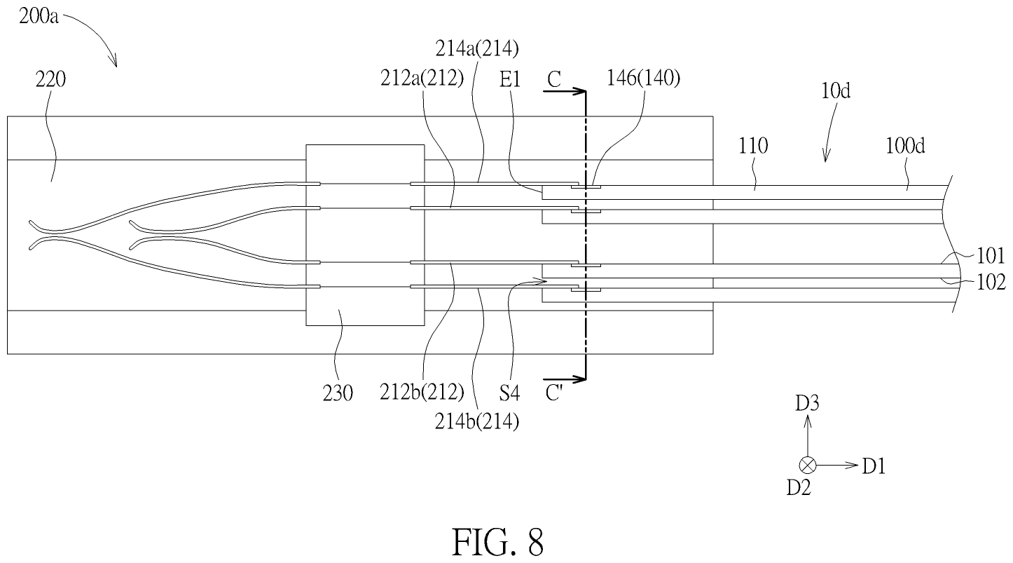

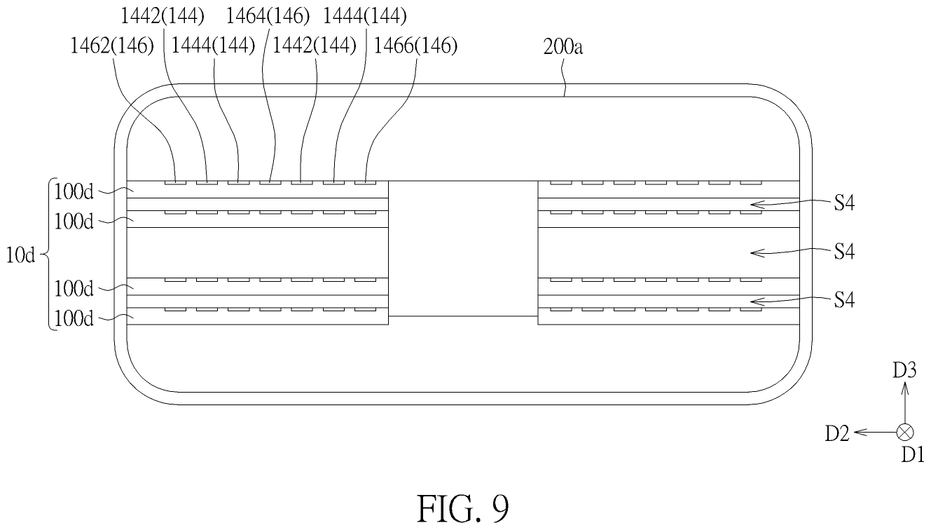

Please refer to FIG. 8 and FIG. 9, FIG. 8 is a combination schematic diagram of a connecting structure 10d and a connector 200a according to yet another embodiment of the present disclosure, FIG. 9 schematically illustrates a cross-sectional view taken along a line C-C′ in FIG. 8. In FIG. 8, the connecting structure 10d includes four flexible flat cables 100d. The structure of the flexible flat cable 100d may be the same as the structure of the flexible flat cable 100a shown in FIG. 1, the structure of the flexible flat cable 100b shown in FIG. 6 or the structure of the flexible flat cable 100c shown in FIG. 7. For the sake of simplicity, only the first end portions 110 of the flexible flat cables 100d are shown. The first pad regions 140 of the flexible flat cables 100d overlap each other in the vertical direction D3, and there is an accommodating space S4 between two first end portions 110 of two adjacent flexible flat cables 100d in the vertical direction D3. Specifically, the left ends E1 of the first end portions 110 of the flexible flat cables 100d are aligned with each other in the vertical direction D3. Each of the flexible flat cables 100d has a first surface 101 and a second surface 102 opposite to the first surface 101. The first pad region 140 is disposed on the first surface 101, and the first surface 101 of the flexible flat cable 100d faces the second surface 102 of another flexible flat cable 100d disposed thereabove. More specifically, the first surfaces 101 of the four flexible flat cables 100d are all arranged to face the same direction, herein face upwardly, and the second surfaces 102 of the four flexible flat cables 100d are all arranged to the same direction, herein face downwardly.

The connector 200a may include a fixed base 230, a housing 220 and a plurality of terminal pairs 212 and a plurality of terminal pairs 214. Each of the terminal pairs 212 includes a first terminal 212a and a second terminal 212b. Each of the terminal pairs 214 includes a first terminal 214a and a second terminal 214b. Each of the right ends of the first terminal 212a and the second terminal 212b may be inserted into the accommodating space S4 to electrically contact the ground pad 146 or the signal pad 144 of one of the flexible flat cables 100d. Similarly, each of the right ends of the first terminal 214a and the second terminal 214b may be electrically contact the ground pad 146 or the signal pad 144 of one of the flexible flat cables 100d. The left ends of the first terminal 212a and the second terminal 212b may form a clip to clamp a portion of an electrical device (such as the first device 30 shown in FIG. 16). Similarly, the left ends of the first terminal 214a and the second terminal 214b may form a clip to clamp another portion of the electrical device. The connector 200a may be a component of the connecting structure 10d or the electrical device. The connector 200a may also be an independent component for connecting the connecting structure 10d and the electrical device.

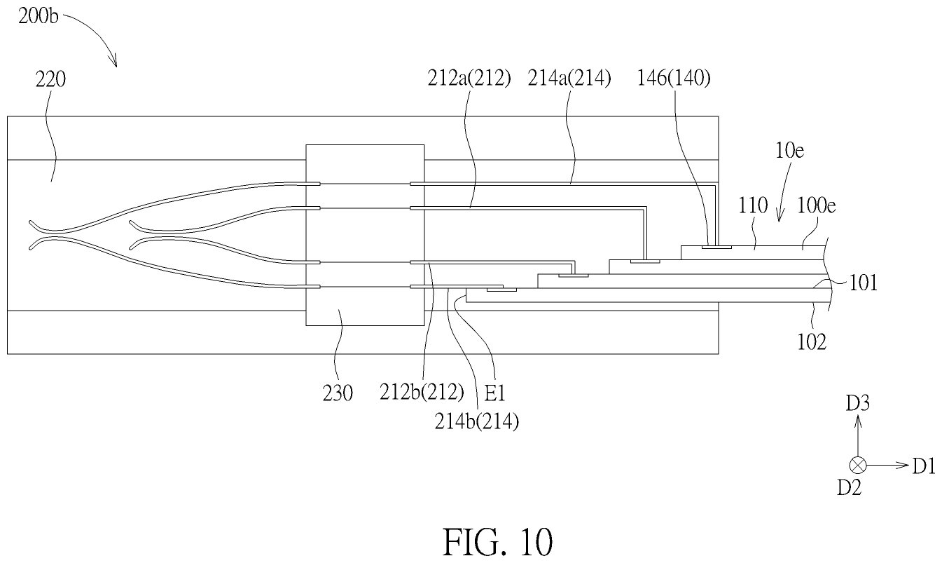

Please refer to FIG. 10, which is a combination schematic diagram of a connecting structure 10e and a connector 200b according to yet another embodiment of the present disclosure. In FIG. 10, the connecting structure 10e includes four flexible flat cables 100e. The structure of the flexible flat cable 100e may be the same as the structure of the flexible flat cable 100a shown in FIG. 1, the structure of the flexible flat cable 100b shown in FIG. 6 or the structure of the flexible flat cable 100c shown in FIG. 7. For the sake of simplicity, only the first end portions 110 of the flexible flat cables 100e are shown. The main difference between the connecting structure 10e shown in FIG. 10 and the connecting structure 10d shown in FIG. 8 is the arrangement of the flexible flat cables 100e. The first pad regions 140 of the flexible flat cables 100e do not overlap each other in the vertical direction D3, and are misaligned with each other to form a step shape. More specifically, the left ends E1 of the first end portions 110 of the flexible flat cables 100e, from bottom to top, are displaced to the right side gradually along the length direction D1, so as to form the step shape. There is no accommodating space S4 between two first end portions 110 of two adjacent flexible flat cables 100e in the vertical direction D3. Moreover, the shapes of the right ends of the first terminals 212a and 214a and the second terminal 212b are changed so to electrically contact the ground pad 146 or the signal pad 144. Specifically, the shape of each of the right ends of the first terminals 212a and 214a and the second terminal 212b is changed from a straight shape to an L shape.

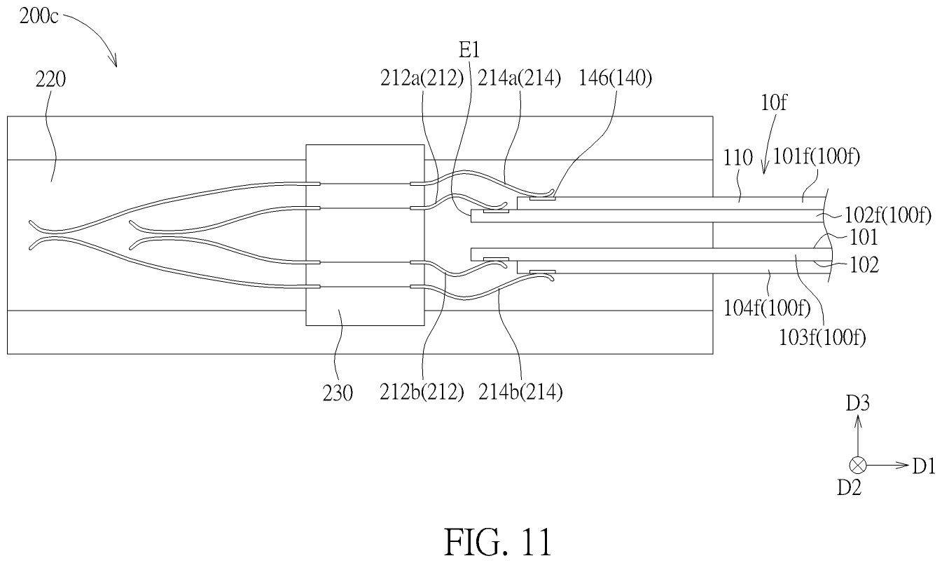

Please refer to FIG. 11, which is a combination schematic diagram of the connecting structure 10f and a connector 200c according to yet another embodiment of the present disclosure. In FIG. 11, the connecting structure 10f includes four flexible flat cables 100f. The structure of the flexible flat cable 100f may be the same as the structure of the flexible flat cable 100a shown in FIG. 1, the structure of the flexible flat cable 100b shown in FIG. 6 or the structure of the flexible flat cable 100c shown in FIG. 7. For the sake of simplicity, only the first end portions 110 of the flexible flat cables 100f are shown. The main difference between the connecting structure 10f shown in FIG. 11 and the connecting structure 10d shown in FIG. 8 is the arrangement of the flexible flat cables 100f. For the sake of explanation, the four flexible flat cables 100f are respectively named as a first flexible flat cable 101f, a second flexible flat cable 102f, a third flexible flat cable 103f and a fourth flexible flat cable 104f from top to bottom. The first pad region 140 of the first flexible flat cable 101f and the first pad region 140 of the second flexible flat cable 102f do not overlap in the vertical direction D3 and are misaligned with each other to form a step shape. The first pad region 140 of the third flexible flat cable 103f and the first pad region 140 of the fourth flexible flat cable 104f do not overlap in the vertical direction D3 and are misaligned with each other to form a step shape. The first pad region 140 of the first flexible flat cable 101f and the first pad region 140 of the fourth flexible flat cable 104f overlap in the vertical direction D3, and the first pad region 140 of the second flexible flat cable 102f and the first pad region 140 of the third flexible flat cable 103f overlap in the vertical direction D3. More specifically, the left end E1 of the first flexible flat cable 101f is aligned with the left end E1 of the fourth flexible flat cable 104f in the vertical direction D3, and the left end E1 of the second flexible flat cable 102f is aligned with the left end E1 of the third flexible flat cable 103f in the vertical direction D3.

There is no accommodating space S4 (see FIG. 8) between two first end portions 110 of the first flexible flat cable 101f and the second flexible flat cable 102f in the vertical direction D3, and there is no accommodating space S4 (see FIG. 8) between two first end portions 110 of the third flexible flat cable 103f and the fourth flexible flat cable 104f in the vertical direction D3. Moreover, the shapes of the right ends of the first terminal 212a and the second terminal 212b are changed so to form a clip to clamp and electrically contact the ground pad 146 or the signal pad 144, and the shapes of the right ends of the first terminal 214a and the second terminal 214b are changed so to form a clip to clamp and electrically contact the ground pad 146 or the signal pad 144. Therefore, the connecting structure 10f may be assembled with the connector 200c in a pluggable manner, which is favorable for simplify the assembling process.

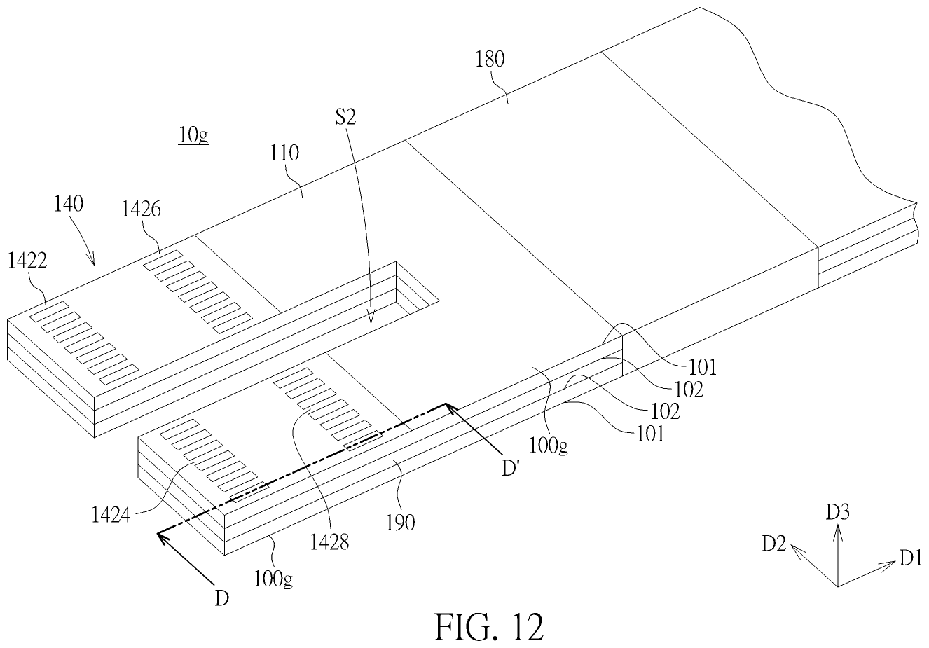

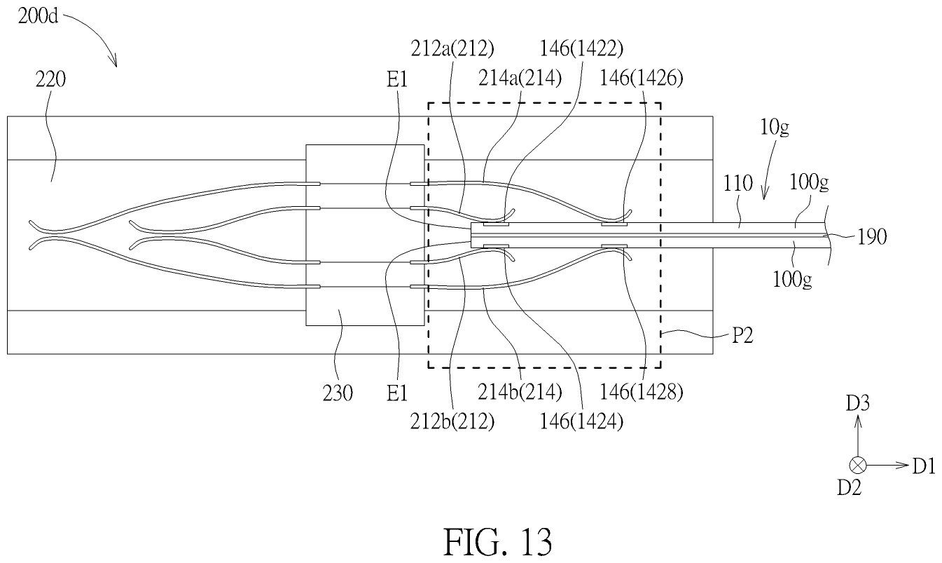

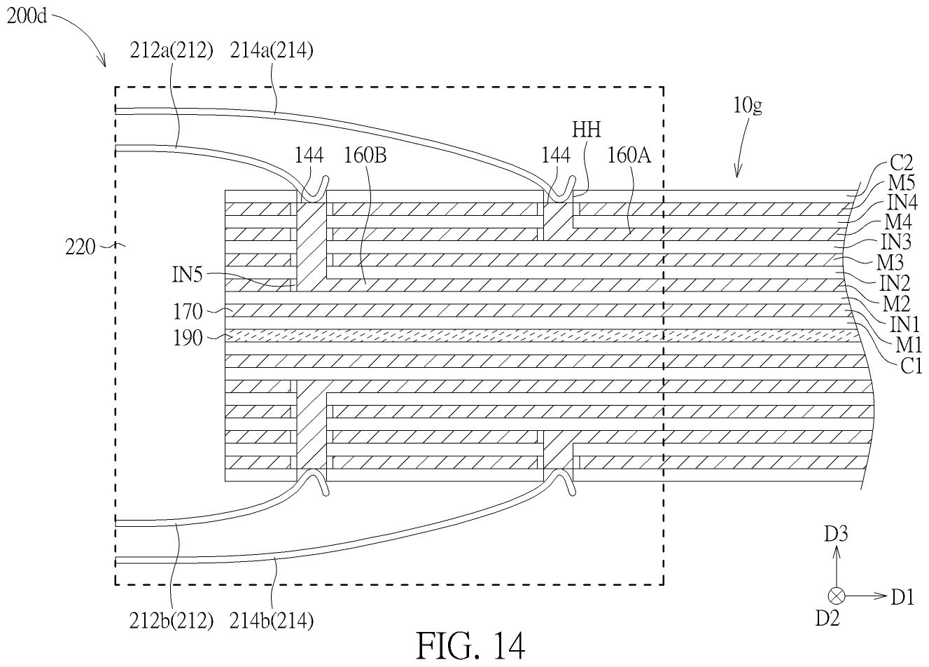

Please refer to FIG. 12, FIG. 13 and FIG. 14. FIG. 12 is a three-dimensional diagram showing a portion of a connecting structure 10g according to yet another embodiment of the present disclosure. FIG. 13 is a combination schematic diagram of the connecting structure 10g and a connector 200d according to yet another embodiment of the present disclosure. FIG. 14 schematically illustrates a cross-sectional view of the portion P2 shown in FIG. 13, and the view angle of FIG. 14 is corresponding to a line D-D′ shown in FIG. 12. In FIG. 12, the connecting structure 10g includes two flexible flat cables 100g. Each of the flexible flat cables 100g has a first surface 101 and a second surface 102 opposite to the first surface 101, the first pad region 140 is disposed on the first surface 101, and the second surface 102 of one of the flexible flat cables 100g faces the second surface 102 of another one of the flexible flat cables 100g. The first pad region 140 includes a first sub-pad region 1422, a second sub-pad region 1424, a third sub-pad region 1426 and a fourth sub-pad region 1428, the first sub-pad region 1422 and the third sub-pad region 1426 are arranged along the length direction D1, and the second sub-pad region 1424 and the fourth sub-pad region 1428 are arranged along the length direction D1. The flexible flat cable 100g further includes a recess S2 formed between the first sub-pad region 1422 and the second sub-pad region 1424 and between the third sub-pad region 1426 and the fourth sub-pad region 1428.

As shown in FIG. 13, the left ends E1 of the two flexible flat cables 100g are aligned with each other in the vertical direction D3. The connector 200d includes a plurality of terminal pairs 212 and 214 corresponding to a plurality of signal pads 144 and a plurality of ground pads 146 of the first pad region 140. The plurality of terminal pairs 212 and 214 clamp the first end portion 110 and respectively contact the plurality of signal pads 144 and the plurality of ground pads 146. The main difference between the connector 200d and the connector 200c shown in FIG. 11 is the configuration of the right end of the first terminals 212a, 214a and the second terminals 212b, 214b. Specifically, due to the first sub-pad region 1422 and the third sub-pad region 1426 being disposed on a same plane (i.e., the first sub-pad region 1422 and the third sub-pad region 1426 being coplanar), and the second sub-pad region 1424 and the fourth sub-pad region 1428 being disposed on a same plane (i.e., the second sub-pad region 1424 and the fourth sub-pad region 1428 being coplanar), the portion of the first terminal 212a and the portion of the first terminal 214a contacting the flexible flat cable 100g are coplanar, and the portion of the second terminal 212b and the portion of the second terminal 214b contacting the flexible flat cable 100g are coplanar.

As shown in FIG. 14, the laminated structure includes, from bottom to top, a protective layer C1, a metal layer M1, an insulating layer IN1, a metal layer M2, an insulating layer IN2, a metal layer M3, an insulating layer IN3, a metal layer M4, an insulating layer IN4, a metal layer M5 and a protective layer C2. The signal pads 144 and the ground pads 146 are exposed from the holes HH formed in the protective layer C2. A portion of the metal layer M2, the metal layer M3, the metal layer M4 and the metal layer M5 together form the lower set of signal trace pattern 160B. Another portion of the metal layer M4 and another portion the metal layer M5 together form the upper set of signal trace pattern 160A. The metal layer M1 below the portion of the metal layer M2 being the lower set of signal trace pattern 160B and the metal layer M3 above the portion of the metal layer M2 being the lower set of signal trace pattern 160B form a shielding structure 170 surrounds the lower set of signal trace pattern 160B, and the shielding structure 170 and the lower set of signal trace pattern 160B are electrically isolated with each other. For example, the insulating structure IN5 may be disposed between the shielding structure 170 and the lower set of signal trace pattern 160B. The metal layer M3 below the portion of the metal layer M4 being the upper set of signal trace pattern 160A and the metal layer M5 above the portion of the metal layer M4 being the upper set of signal trace pattern 160A form a shielding structure 170 surrounds the upper set of signal trace pattern 160A, and the shielding structure 170 and the upper set of signal trace pattern 160A are electrically isolated with each other. For example, an insulating structure IN5 may be disposed between the shielding structure 170 and the upper set of signal trace pattern 160A. That is, the shielding structure 170 is disposed between the upper set of signal trace pattern 160A and the lower set of signal trace pattern 160B. Herein, the upper set of signal trace pattern 160A refers to the signal trace pattern which is closer to the first surface 101 along the vertical direction D3, and the lower set of signal trace pattern 160B refers to the signal trace pattern which is closer to the second surface 102 along the vertical direction D3. That is, the main difference between the flexible flat cable 100g and the flexible flat cables 100a (see FIG. 3 and FIG. 4) is the number of the layers of the flexible flat cable 100g being different from that of the flexible flat cables 100a. The upper set of signal trace pattern 160A and the lower set of signal trace pattern 160B form a double-layer signal trace pattern, which is favorable for enhancing the channel density.

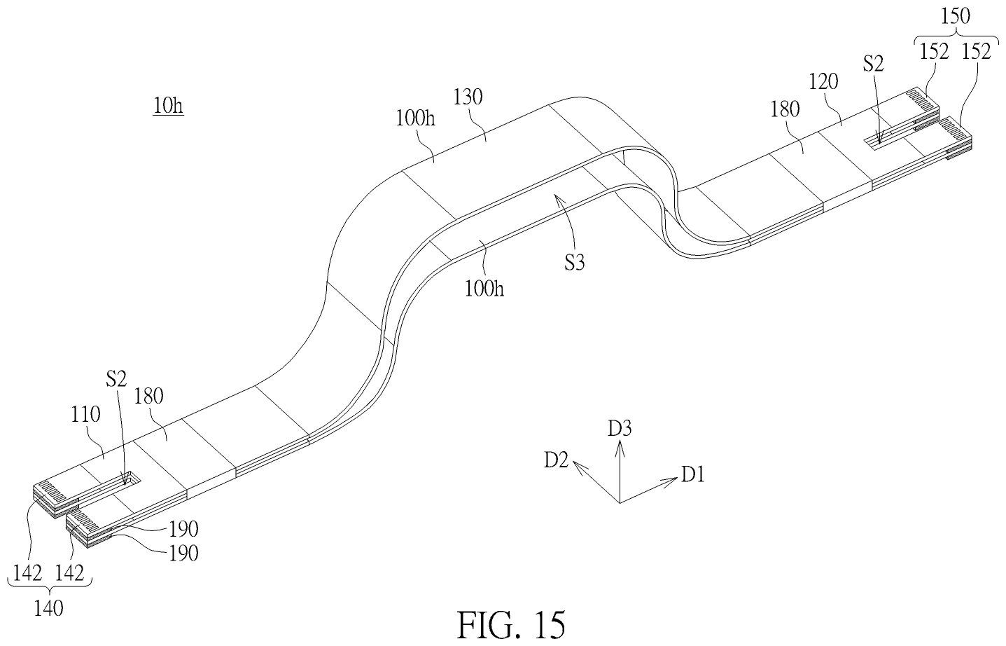

Please refer to FIG. 15, which is a three-dimensional diagram showing a connecting structure 10h according to yet another embodiment of the present disclosure. As shown in FIG. 15, the main difference between the flexible flat cable 100h and the flexible flat cable 100a shown in FIG. 1 is the connecting portion 130 of the flexible flat cable 100h is not formed with the slot S1. For details of the flexible flat cable 100h, reference may be made to that of the flexible flat cable 100a shown in FIG. 1. Specifically, the connecting structure 10h includes two flexible flat cables 100h and two fixing member 180. Each of the flexible flat cables 100h includes a first end portion 110, a second end portion 120, a connecting portion 130, a first pad region 140 and a second pad region 150. The connecting portion 130 is connected between the first end portion 110 and the second end portion 120. The first pad region 140 is disposed on the first end portion 110. The second pad region 150 is disposed on the second end portion 120. The flexible flat cable 100h is a laminated structure including at least one set of signal trace pattern 160 (see FIG. 3) and at least one shielding structure 170 (see FIG. 3). The at least one shielding structure 170 correspondingly surrounds the at least one set of signal trace pattern 160 in the connecting portion 130. The two flexible flat cables 100h are arranged along a vertical direction D3, and there is a space S3 between the two connecting portions 130 of the two flexible flat cables 100h. One of the fixing members 180 is disposed at one side of the connecting portion 130 of each of the two flexible flat cables 100h adjacent to the first end portion 110 to bond the two flexible flat cables 100h, and the other one of the fixing members 180 is disposed at one side of the connecting portion 130 of each of the two flexible flat cables 100h adjacent to the second end portion 120 to bond the two flexible flat cables 100h. With the space S3, it is favorable for reducing stress when the two flexible flat cables 100h are assembled on a hard board. With the fixing member 180, it is favorable for simultaneously picking or moving the two flexible flat cables 100h, which is favorable for simplifying the assembling process, so as to improve the assembly convenience.

Please refer to FIG. 16 and FIG. 17. FIG. 16 is a schematic diagram showing a signal transmission system 1 according to an embodiment of the present disclosure. FIG. 17 is a three-dimensional diagram showing the connector 200e and the connecting structure 10 shown in FIG. 16, which is corresponding to the portion P3 shown in FIG. 16. The signal transmission system 1 includes a system board 20, a first device 30, a second device 40 and a connecting structure 10. The first device 30 is coupled to the system board 20. The first device 30 is configured to provide a high-speed signal HS and a low-speed signal LS. The second device 40 is coupled to the system board 20. The connecting structure 10 includes four flexible flat cables 100. Each of the flexible flat cables 100 includes a first end portion 110, a second end portion 120, a connecting portion 130, a first pad region (not shown) and a second pad region (not shown). The first end portion 110 and the second end portion 120 are respectively coupled to the first device 30 and the second device 40. The first pad region is disposed on the first end portion 110. The second pad region is disposed on the second end portion 120. The flexible flat cable 100 is a laminated structure including at least one set of signal trace pattern (not shown) and at least one shielding structure (not shown). The at least one shielding structure correspondingly surrounds the at least one set of signal trace pattern in the connecting portion 130. The low-speed signal LS is transmitted from the first device 30 to the second device 40 through the system board 20, and the high-speed signal HS is transmitted from the first device 30 to the second device 40 through the connecting structure 10.

The first end portion 110 of the flexible flat cable 100 is coupled to the first device 30 through the connector 200e, and the second end portion 120 of the flexible flat cable 100 is coupled to the second device 40 through the connector 200f. More specifically, both the connector 200f and the second device 40 are coupled to the system board 20 and electrically connected with each other through the trace pattern 24 of the system board 20. That is, the second end portion 120 of the flexible flat cable 100 is coupled to the second device 40 through the connector 200f and the system board 20.

As shown in FIG. 17, the connector 200e may include a fixed base 230, a housing 220, two sets of high-speed signal terminal pairs 240 and a set of low-speed signal terminal pairs 250. The set of low-speed signal terminal pairs 250 is located between the two sets of high-speed signal terminal pairs 240 and is corresponding to the recess S2 of the flexible flat cable 100. Each of the sets of high-speed signal terminal pairs 240 includes seven terminal pairs 212 and seven terminal pairs 214. The set of low-speed signal terminal pairs 250 includes five terminal pairs 212 and five terminal pairs 214. Each of the terminal pairs 212 includes a first terminal 212a and a second terminal 212b. Each of the terminal pairs 214 includes a first terminal 214a and a second terminal 214b. The left ends of the terminal pairs 212 and 214 of the set of high-speed signal terminal pairs 240 protrude from the fixed base 230 to form clips to clamp the first device 30, and the right ends of the terminal pairs 212 and 214 of the set of high-speed signal terminal pairs 240 protrude from the fixed base 230 to electrically connect (or physically contact) with the signal pads and the ground pads on the first pad regions of the flexible flat cables 100. The left ends of the terminal pairs 212 and 214 of the set of low-speed signal terminal pairs 250 protrude from the fixed base 230 to form clips to clamp the first device 30, and the right ends of the terminal pairs 212 and 214 of the set of low-speed signal terminal pairs 250 protrude from the fixed base 230 and bend downwardly to electrically connect (or physically contact) with the trace pattern 22 of the system board 20. Thereby, the low-speed signal LS is transmitted from the first device 30 to the second device 40 through the system board 20, and the high-speed signal HS is transmitted from the first device 30 to the second device 40 through flexible flat cables 100 of the connecting structure 10. Compared with both the high-speed signal HS and the low-speed signal LS being transmitted through the system board 20, it is favorable for reducing the insertion loss when the high-speed signal HS is transmitted through the flexible flat cables 100. Compared with both the high-speed signal HS and the low-speed signal LS being transmitted through the flexible flat cables 100, it is favorable for reducing cost when the low-speed signal LS being transmitted through the system board 20.

The system board 20, for example, may be a printed circuit board (PCB) or a switch host board. The first device 30, for example, may be a pluggable optical module. The connector 200e, for example, may be a quad small form factor pluggable-double density (QSFP-DD) connector. The first device 30, for example, may be connected with the connector 200e in a pluggable manner. The second device 40, for example, may be an integrated circuit such as an application specific integrated circuit (ASIC). The signal transmission system 1, for example, may be a network communication system.

The high-speed signal HS may refer to a signal with a speed greater than or equal to 112 Gbits/sec, and the low-speed signal LS may refer to a signal with a speed less than 112 Gbits/sec. For example, the low-speed signal LS may be applied to transmit low-frequency signals, control signals, power, or ground

In FIG. 16, the number of the flexible flat cables 100 is four, which is exemplarily and the present disclosure is not limited thereto. The flexible flat cable 100 may be the aforementioned flexible flat cable 100a, 100b, 100c, 100d, 100e, 100f, 100g or 100h. Also, the connecting structure 10 may be replaced by the aforementioned connecting structure 10a, 10b, 10c, 10d, 10e, 10f, 10g or 10h, and the structure of the connector 200e and the structure of the connector 200f may be adjusted accordingly.

According to the present disclosure, the connecting structure includes a flexible flat cable. Compared with the PCB, it is favorable for reducing the insertion loss by transmitting signals through the flexible flat cable. Therefore, the connecting structure according to the present disclosure is favorable for the application of high-speed signal transmission. Compared with the twinax cable, it is favorable for simplifying the assembling process by using the flexible flat cable to transmit signals. Accordingly, it may reduce the entire assembly cost. The flexible flat cable may include a slot formed in the connecting portion thereof, which is favorable for reducing the bending stress and/or twist stress during assembly. The flexible flat cable may include a recess formed between the two sub-pad regions of the first pad region, which is favorable for transmitting the high-speed signal and the low-speed signal separately, and thus may provide a better isolation degree for the high-speed signal and the low-speed signal. Moreover, it is favorable for maintain the property of the high-speed signal. The connecting structure may include a plurality of flexible flat cables arranged along the vertical direction, which is favorable for increasing the channel density, and is favorable for enhancing the flow efficiency of the cooling air, and may provide a better cooling effect. The connecting structure may include a space between two connecting portions of two flexible flat cables, which is favorable for the two flexible flat cables being configured with different lengths, so that the two flexible flat cables may be used to transmit signals with different properties. The connecting structure may include a fixing member disposed at one side of the connecting portion of each of the flexible flat cables adjacent to the first end portion to bond the flexible flat cables, which is favorable for simultaneously picking or moving the plurality of flexible flat cables, so that the flexible flat cables may be assembled with a connector at the same time. The connecting structure may include a spacer disposed between the two first end portions of two adjacent flexible flat cables, which is beneficial to reduce the crosstalk between the two flexible flat cables, and is beneficial to strengthen the structural strength.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connecting structure, comprising:
a flexible flat cable, comprising:
a first end portion, a second end portion and a connecting portion connected between the first end portion and the second end portion;
a first pad region disposed on the first end portion and a second pad region disposed on the second end portion; and
a slot formed in the connecting portion, wherein the slot is extended along a length direction of the flexible flat cable;
wherein the flexible flat cable is a laminated structure comprising at least one set of signal trace pattern and at least one shielding structure, and the at least one shielding structure correspondingly surrounds the at least one set of signal trace pattern in the connecting portion.

2. The connecting structure of claim 1, wherein the first pad region comprises two sub-pad regions, and the flexible flat cable further comprises a recess formed between the two sub-pad regions.

3. The connecting structure of claim 2, wherein the slot is aligned with the recess along the length direction of the flexible flat cable.

4. The connecting structure of claim 1, wherein a number of the flexible flat cables is two, and the two flexible flat cables are arranged along a vertical direction.

5. The connecting structure of claim 4, wherein there is a space between the two connecting portions of the two flexible flat cables.

6. The connecting structure of claim 4, further comprising:
a fixing member disposed at one side of the connecting portion of each of the two flexible flat cables adjacent to the first end portion to bond the two flexible flat cables.

7. The connecting structure of claim 4, wherein the two first end portions of the two flexible flat cables are bonded with each other.

8. The connecting structure of claim 7, wherein the two first end portions of the two flexible flat cables are bonded with each other through a spacer, and the spacer overlaps the two first end portions of the two flexible flat cables.

9. The connecting structure of claim 4, wherein the two second end portions of the two flexible flat cables are separated from each other.

10. The connecting structure of claim 4, wherein the two first pad regions of the two flexible flat cables overlap each other in the vertical direction, and there is an accommodating space between the two first end portions of the two flexible flat cables in the vertical direction.

11. The connecting structure of claim 4, wherein the two first pad regions of the two flexible flat cables do not overlap each other in the vertical direction, and are misaligned with each other to form a step shape.

12. The connecting structure of claim 4, wherein each of the flexible flat cables has a first surface and a second surface opposite to the first surface, the first pad region is disposed on the first surface, and the first surface of one of the flexible flat cables faces the second surface of another one of the flexible flat cables.

13. The connecting structure of claim 4, wherein each of the flexible flat cables has a first surface and a second surface opposite to the first surface, the first pad region is disposed on the first surface, and the second surface of one of the flexible flat cables faces the second surface of another one of the flexible flat cables.

14. The connecting structure of claim 4, further comprising:
a spacer disposed between the two first end portions of the two flexible flat cables, the spacer overlaps the two first end portions of the two flexible flat cables, and the spacer is made of conductive material.

15. The connecting structure of claim 1, wherein a number of the flexible flat cables is four, the four flexible flat cables are arranged along a vertical direction, the four flexible flat cables are respectively a first flexible flat cable, a second flexible flat cable, a third flexible flat cable and a fourth flexible flat cable from top to bottom, the first pad region of the first flexible flat cable and the first pad region of the second flexible flat cable do not overlap in the vertical direction and are misaligned with each other to form a step shape, the first pad region of the third flexible flat cable and the first pad region of the fourth flexible flat cable do not overlap in the vertical direction and are misaligned with each other to form a step shape, the first pad region of the first flexible flat cable and the first pad region of the fourth flexible flat cable overlap in the vertical direction, and the first pad region of the second flexible flat cable and the first pad region of the third flexible flat cable overlap in the vertical direction.

16. The connecting structure of claim 1, wherein the at least one set of signal trace pattern is electrically connected to a signal pad disposed on the first pad region, and the at least one shielding structure is electrically connected to a ground pad disposed on the first pad region.

17. The connecting structure of claim 16, wherein the at least one set of signal trace pattern and the at least one shielding structure overlap in a width direction of the flexible flat cable in the first end portion.

18. The connecting structure of claim 16, wherein the at least one set of signal trace pattern comprises a first signal trace pattern and a second signal trace pattern arranged along a width direction of the flexible flat cable.

19. The connecting structure of claim 18, wherein the first signal trace pattern and the second signal trace pattern form a differential signal pair.

20. The connecting structure of claim 1, wherein the flexible flat cable comprises a plurality of sets of signal trace patterns and a plurality of shielding structures, and the plurality of shielding structures correspondingly and respectively surround the plurality of sets of signal trace patterns.

21. The connecting structure of claim 1, wherein the first pad region comprises a first ground pad, a first signal pad, a second signal pad and a second ground pad arranged in sequence along a width direction of the flexible flat cable.

22. The connecting structure of claim 1, wherein the first pad region comprises a first sub-pad region, a second sub-pad region, a third sub-pad region and a fourth sub-pad region, the first sub-pad region and the third sub-pad region are arranged along the length direction, the second sub-pad region and the fourth sub-pad region are arranged along the length direction, and the flexible flat cable further comprises a recess formed between the first sub-pad region and the second sub-pad region and between the third sub-pad region and the fourth sub-pad region.

23. The connecting structure of claim 22, wherein the flexible flat cable comprises two sets of signal trace patterns, and the two sets of signal trace patterns are an upper set of signal trace pattern and a lower set of signal trace pattern, and the at least one shielding structure is disposed between the upper set of signal trace pattern and the lower set of signal trace pattern.

24. The connecting structure of claim 1, further comprising:
a connector comprising a plurality of terminal pairs corresponding to a plurality of signal pads of the first pad region, wherein the plurality of terminal pairs clamp the first end portion and respectively contact the plurality of signal pads.

25. A signal transmission system, comprising:
a system board;
a first device coupled to the system board, wherein the first device is configured to provide a high-speed signal and a low-speed signal;
a second device coupled to the system board; and
a connecting structure comprising a flexible flat cable, wherein the flexible flat cable comprises:
a first end portion, a second end portion and a connecting portion connected between the first end portion and the second end portion, wherein the first end portion and the second end portion are respectively coupled to the first device and the second device; and
a first pad region disposed on the first end portion and a second pad region disposed on the second end portion;
wherein the flexible flat cable is a laminated structure comprising at least one set of signal trace pattern and at least one shielding structure, and the at least one shielding structure correspondingly surrounds the at least one set of signal trace pattern in the connecting portion;
wherein the low-speed signal is transmitted from the first device to the second device through the system board, and the high-speed signal is transmitted from the first device to the second device through the connecting structure.

26. The signal transmission system of claim 25, wherein the high-speed signal is transmitted in a speed greater than or equal to 112 Gbits/sec.

27. A connecting structure, comprising:
two flexible flat cables, each of the flexible flat cables comprising:
a first end portion, a second end portion and a connecting portion connected between the first end portion and the second end portion; and
a first pad region disposed on the first end portion and a second pad region disposed on the second end portion, wherein each of the flexible flat cables is a laminated structure comprising at least one set of signal trace pattern and at least one shielding structure, and the at least one shielding structure correspondingly surrounds the at least one set of signal trace pattern in the connecting portion, the two flexible flat cables are arranged along a vertical direction, and there is a space between the two connecting portions of the two flexible flat cables; and
a fixing member disposed at one side of the connecting portion of each of the two flexible flat cables adjacent to the first end portion to bond the two flexible flat cables.
